(19) United States
(12) Patent Application Publication
(10) Pub. No.: US 2019/0286542 A1
(43) Pub. Date: Sep. 19, 2019

(54) RECORD AND REPLAY SYSTEM AND METHOD FOR AUTOMATING ONE OR MORE ACTIVITIES

(71) Applicant: HCL Technologies Limited, Noida (IN)

(72) Inventors: Venkatesh SHANKAR, Chennai (IN); Simy CHACKO, Chennai (IN)

(21) Appl. No.: 16/296,238

(22) Filed: Mar. 8, 2019

(30) Foreign Application Priority Data
Mar. 19, 2018 (IN) 201811009935

(51) Int. Cl. G06F 11/34; G06F 16/28; G06F 17/27

(52) U.S. Cl. CPC G06F 11/3476; G06F 11/3438; G06F 17/278; G06F 16/285

(57) ABSTRACT

The present disclosure relates to a record and replay system(s) and method(s) for automating one or more activities with self-learning, the method comprises obtaining data from one or more data source systems and identifying an intent associated with the data based on classification of the data in to one or more domain using a clustering and classification methodology. The method further comprises extracting one or more parameters from the data and a parameters databased based on the intent using a named entity recognition extractor and identifying the activity to be performed based on the one or more parameters and the intent. The method furthermore comprises executing the activity using the one or more parameter, thereby automating execution of one or more activities.

### CROSS-REFERENCE TO RELATED APPLICATIONS AND PRIORITY

The present application claims benefit from Indian Complete Patent Application No. 201811009935 filed on 19 Mar. 2018 the entirety of which is hereby incorporated by reference.

### TECHNICAL FIELD

The present disclosure in general relates to the field of automation. More particularly, the present subject matter relates to a record and replay system and a method for automating one or more activities with self-learning.

### BACKGROUND

Now a day, organizations business complexity has increased may fold and organization are using automation at a large scale. Automation can be defined as the technology by which a process or procedure is performed without human assistance. In other words, Automation or automatic control is the use of various control systems for operating equipment such as machinery, processes in factories, boilers and heat-treating ovens, switching on telephone networks, steering and stabilization of ships, aircraft and other applications and vehicles with minimal or reduced human intervention. Typically, automation has been achieved by various means including mechanical, hydraulic, pneumatic, electrical, electronic devices and computers, usually in combination. Systems, such as modern factories, airplanes and ships typically use all these combined techniques. In other words automation emphasizes the intersect between and hardware and software.

### SUMMARY

Before the present a record and replay system and a method for automating one or more activities with self-learning, are described, it is to be understood that this application is not limited to the particular record and replay system, record and replay systems, and methodologies described, as there can be multiple possible embodiments, which are not expressly illustrated in the present disclosures. It is also to be understood that the terminology used in the description is for the purpose of describing the particular implementations, versions, or embodiments only, and is not intended to limit the scope of the present application. This summary is provided to introduce aspects related to a record and replay system and a method for automating one or more activities with self-learning. This summary is not intended to identify essential features of the claimed subject matter nor is it intended for use in determining or limiting the scope of the claimed subject matter.

In one embodiment, a method for automating one or more activities with self-learning using a record and replay system is disclosed. In the embodiment, the method comprises obtaining data from one or more data source record and replay systems (108). In one example, the data source comprises an enterprise CRM system, file systems log management systems, an email system, device details, errors, and messages and identifying an intent associated with the data based on classification of the data in to one or more domain using a clustering and classification methodology. Upon identifying, the method comprises the step of extracting one or more parameters from the data and parameters databased based on the intent using a named entity recognition extractor and identifying the activity to be performed based on the one or more parameters and the intent. Subsequently, the method comprises executing the activity using the one or more parameters, thereby automating execution of one or more activities using the record and replay system.

In another embodiment, a record and replay system for automating one or more activities with self-learning is disclosed. The record and replay system comprises a memory and a processor coupled to the memory, further the processor may be configured to execute programmed instructions stored in the memory. In one embodiment, the record and replay system may obtain data from one or more data source record and replay systems (108), and identify an intent associated with the data based on classification of the data in to one or more domain using a clustering and classification methodology. In one example, the data source system (108) comprises an enterprise CRM system; file systems log management systems, an email system, device details, errors, and messages. Upon identifying the record and relay system may extract one or more parameters from the data and a parameters databased based on the intent using a named entity recognition extractor and identify the activity to be performed based on the one or more parameters and the intent. Further to identifying the record and replay system may executing the activity using the one or more parameters, thereby automating execution of one or more activities using the record and replay system.

### BRIEF DESCRIPTION OF DRAWINGS

The foregoing detailed description of embodiments is better understood when read in conjunction with the appended drawings. For the purpose of illustrating of the present subject matter, an example of construction of the present subject matter is provided as figures; however, the present subject matter is not limited to the specific method and record and replay system disclosed in the document and the figures.

The present subject matter is described detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a record and replay system for automating one or more activities with self-learning, in accordance with an embodiment of the present subject matter.

FIG. 2A illustrates and embodiment of the record and replay system for automating one or more activities with self-learning, in accordance with an embodiment of the present subject matter.

FIG. 2B illustrates one more embodiment the record and replay system for automating one or more activities with self-learning, in accordance with an embodiment of the present subject matter.

FIG. 3 illustrates a method for automating one or more activities with self-learning, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any a record and replay system and a method for automating one or more activities with self-learning, similar or equivalent to those described herein can be used in the practice or testing of embodiments of the present disclosure, the exemplary, a record and replay system and a method for automating one or more activities with self-learning are now described.

Various modifications to the embodiment will be readily apparent to those skilled in the art and the generic principles herein may be applied to other embodiments for automating one or more activities with self-learning. However, one of ordinary skill in the art will readily recognize that the present disclosure for automating one or more activities with self-learning is not intended to be limited to the embodiments described, but is to be accorded the widest scope consistent with the principles and features described herein.

In another embodiment, a record and replay system and method for automating one or more activities with self-learning is disclosed. In one embodiment, initially data from one or more data source record and replay systems (108) may be obtained. Upon obtaining, an intent associated with the data may be identified based on classification of the data in to one or more domain using a clustering and classification methodology. Upon identifying, one or more parameters may be extracted from the data and parameters databased based on the intent using a named entity recognition extractor and the activity to be performed may be identified based on the one or more parameters and the intent. Further to identifying, the activity may be executed using the one or more parameters, thereby automating execution of one or more activities using a record and replay record and replay system.

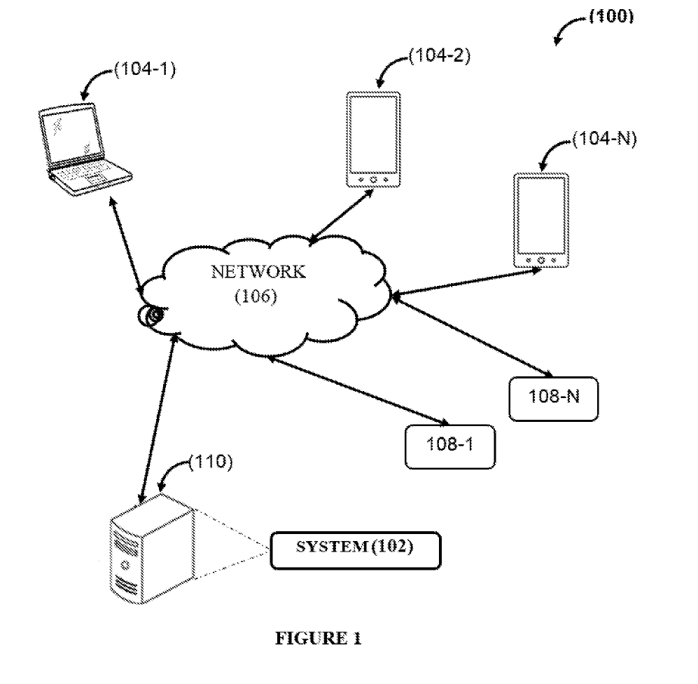

Referring now to FIG. 1, multiple embodiment of a network implementation 100 of a record and replay system 102 for automating one or more activities with self-learning is disclosed. Although the present subject matter is explained considering that the record and replay system 102 is implemented on a server 110, it may be understood that the record and replay system 102 may also be implemented in a variety of computing systems, such as a laptop computer, a desktop computer, a notebook, a workstation, a mainframe computer, a server, a network server, and the like. In one implementation, the record and replay system 102 may be implemented in a cloud-based environment. It will be understood that multiple users may access the record and replay system 102 through one or more user device or applications residing on the user device 104-1 . . . 104-N, herein after individually or collectively referred to as 104. Examples of the user device 104 may include, but are not limited to, a portable computer, a personal digital assistant, a handheld record and replay system, and a workstation. The device 104 may be communicatively coupled to the server 110 through a network 106.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may be either a dedicated network or a shared network. The shared network represents an association of the different types of networks that use a variety of protocols, for example, Hypertext Transfer Protocol (HTTP), Hypertext Transfer Protocol Secure (HTTPS), Secure File Transfer Protocol (SFTP), Transmission Control Protocol/Internet Protocol (TCP/IP), Wireless Application Protocol (WAP), and the like, to communicate with one another. Further, the network 106 may include a variety of network record and replay systems, including routers, bridges, servers, computing record and replay systems, storage record and replay systems, and the like.

In the embodiment, the record and replay system 102 may obtain data from one or more source systems 108-1 . . . 108-N, herein after individually or collectively referred to a source system 108. In one example, the source system 108 may be a CRM system of the organization, an ERP system, email system, chat system file systems log management systems, an email system, device details, errors, and messages. Upon obtaining, the record and replay system may identify an intent associated with the data based on classification of the data in to one or more domain using a clustering and classification methodology and extract one or more parameters from the data and parameters databased based on the intent using a named entity recognition extractor. Further to extracting, the record and replay system 102 may identify the activity to be performed based on the one or more parameters and the intent. Further to identifying the record and replay system 102 may executing the activity using the one or more parameters, thereby automating execution of one or more activities using.

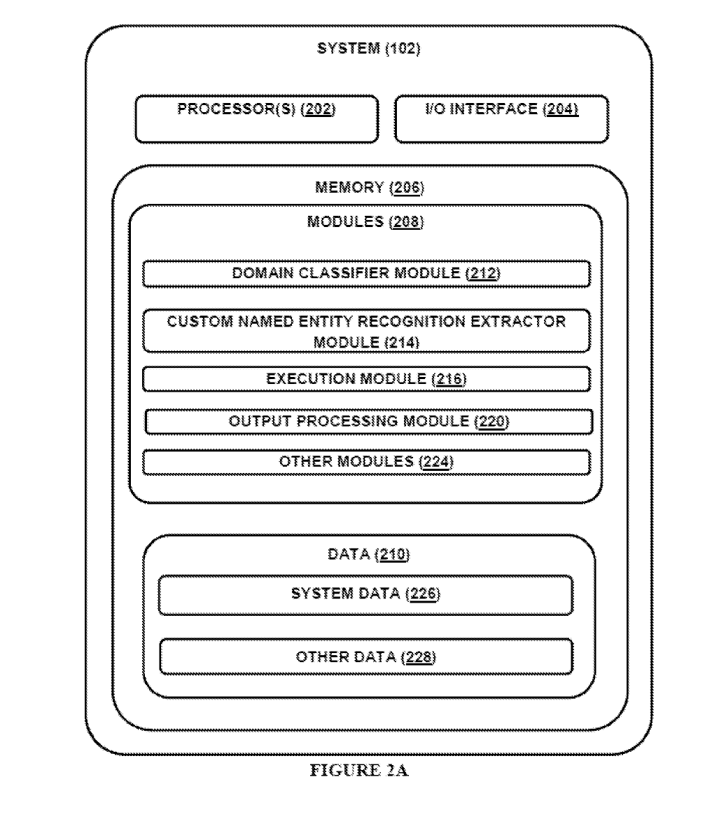

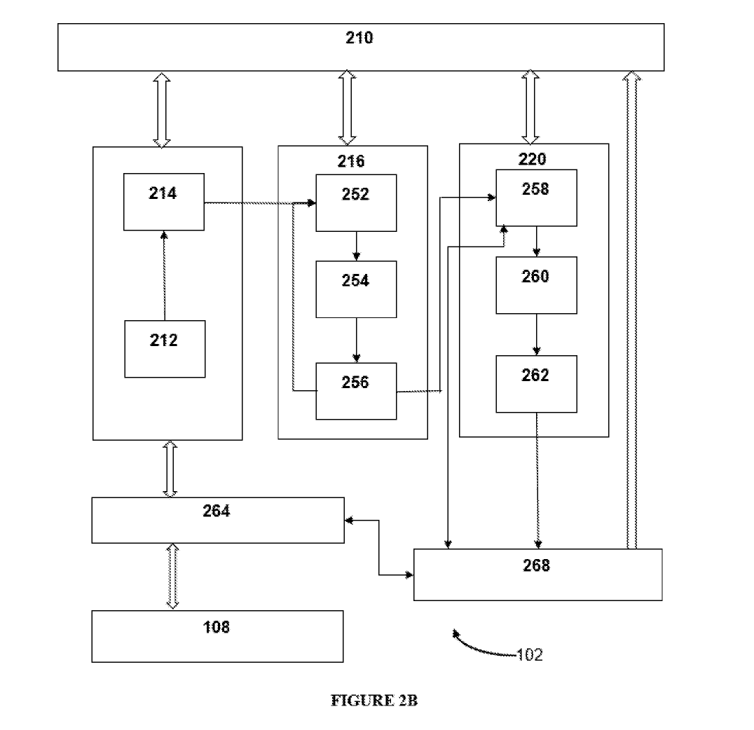

Referring now to FIG. 2A, an embodiment of the record and replay system 102 for automating one or more activities with self-learning is illustrated in accordance with the present subject matter. The record and replay system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any record and replay systems that manipulate signals based on operational instructions. Among other capabilities, at least one processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the record and replay system 102 to interact with the user directly or through the user device 104. Further, the I/O interface 204 may enable the record and replay system 102 to communicate with other computing record and replay systems, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of record and replay systems to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 may include routines, programs, objects, components, data structures, and the like, which perform particular tasks, functions or implement particular abstract data types. In one implementation, the module 208 may include a domain classifier module 212, a custom named entity recognition extractor module 214, an execution module 216, an output processing module 220, and other modules 224. The other modules 224 may include programs or coded instructions that supplement applications and functions of the record and replay system 102.

The data 210, amongst other things, serve as a repository for storing data processed, received, and generated by one or more of the modules 208. The data 210 may also include a system data 226, and other data 228. In one embodiment, the other data 228 may include data generated as a result of the execution of one or more modules in the other module 224.

In one implementation, a user may access the record and replay system 102 via the I/O interface 204. The user may be registered using the I/O interface 204 in order to use the record and replay system 102. In one aspect, the user may access the I/O interface 204 of the record and replay system 102 for obtaining information, providing inputs, configuring or implementing the record and replay system 102.

### Domain Classifier Module 212

In the embodiment, the domain classifier module 212 may obtain data from one or more data source systems (108). In one example, the data source system (108) may comprise an enterprise CRM system, file systems log management systems, an email system, device details, errors, and messages. Further to obtaining, the domain classifier module 212 may identify an intent associated with the data based on classification of the data in to one or more domain using a clustering and classification methodology. In one example, of the clustering and classification methodology, words are extracted from the data and based on comparison of the words, data associated with similar words or group of words is clustered in to multiple segments. Upon clustering the data is classified in based on the domain. In one example, domain data based may be medical, network communication and the like. In one example, the intent may be understood as an action to be performed such as test, boot, start and the like. Upon identifying the domain, classifier module 212 may store the classified data and the identified intent in the system data 226.

### Custom Named Entity Recognition Extractor Module 214

Further, in the embodiment, the custom named entity recognition extractor module 214 may extract one or more parameters from the data and parameters databased based on the intent using a named entity recognition extractor. Upon extracting, the custom named entity recognition extractor module 214 may identify the activity to be performed based on the one or more parameters and the intent. Subsequently the custom named entity recognition extractor module 214 may store the parameters and the activity details in system data 226

### Execution Module 216

Furthermore, in the embodiment, the execution module 216 may identifying a recording sequence associated with the activity based on natural language processing of a set of recording sequence and the activity. The recording sequence may be understood as a record of a previously performed same activity executed using the same parameters. Upon identifying, the execution module 216 may execute the activity using the one or more parameter if the recording is not present or may execute the recording sequence if the recording is present, thereby automating execution of one or more activities. Further to executing, the execution module 216 may generate a recording sequence of the execution of the activity and store the recording sequence in the set of recording sequence when the recording sequence is not present.

### Output Processing Module 218

In the embodiment, upon execution, the output processing module 218 may obtain output data generated upon execution of the activity. In one example, the output data may comprise error logs, issues logs and information logs. Further to obtaining, the output processing module 218 may generate one or more tasks based on the output data and assign each of the one or more tasks to one or more users based on the user data.

In the embodiment, subsequent to assigning the output processing module 218 may receive an instruction for re-executing the activity from the one or more user. Further to receiving, the execution module 216 may re-execute the activity using the recording sequence.

Referring now to FIG. 2B, another embodiment of the record and replay system 102 for automating one or more activities with self-learning is illustrated in accordance with the present subject matter. In the embodiment, the record and replay system 102 comprises an internal storage is built to keep the history of all the information flows back and forth in the system. All the minutes are stored and retrieved depending on the tool/process requests.

In the embodiment, the data may be collected by a data import interface 264 from a data source system 108. In one example, the data source system 108 may be one or more of database, logs management. In one other embodiment, the data import interface 264 may collect data periodically using data collectors such as scheduler/polling tool or trigger. Data Import Interface may be used to collect the data from different sources such as database or file system of log files. In one more example, the data import interface 264 may act as an ETL (extraction, transformation, loading).

Further, in the embodiment, the domain classifier module 212 may obtain data form the data import interface 264 and identify an intent. In one example, the domain classifier module 212 may be understood as a control system wherein the domain specific context are gathered based on the classification. Further, the domain classifier module 212 may build a database for segmenting and categorizing the relevant information from the data using clustering and classification algorithms. Furthermore, based on the segmenting and categorizing the intent is identified.

Upon identifying, the custom named entity recognition extractor module 214 may extract one or more parameters from the data and a parameters databased based on the intent using a named entity recognition extractor and may identify the activity to be performed based on the one or more parameters and the intent. In one example, the custom named entity recognition extractor module 214 may be understood as a named entity recognition extractor customized based on the content and intent respectively. In one embodiment, the custom named entity recognition extractor module 214 recognize and extract the entities from the domain specific content. Based on the extracted entities and which goes as a parameter for instrumentation.

Further to identification the execution module 216 may execute the activity using the parameters. Prior to executing, the execution module 216 may identify if the recording sequence is available. In one example, when the recording sequence is available, the execution module 216 may replay the recording sequence using the re-player 256. In the example, re-player 256 may repeat the events captured already in recording sequence. Further, in the example, the re-player system 256 may performs activities, which are done by humans such as modifying router configuration and executing test cases or deleting switch from hardware list and executing peripheral checking.

In one embodiment, the execution module 216 may comprises an instrument tool 252, a recorder 254, and re-player 256. In the example, the instrument tool 252 may performs activities which are done by humans on router, switch, other devices etc. thru commands like ssh, putty. The instrument tool 252 obtains the parameter such as machine name or host IP or other before performing the activity. Further, in the example, the recorder system 254 may record the operation or sequence of events carried out after connecting to the respective instrumented device and store the recording sequences.

Further to execution, the output processing module 220, may post process the output data. In one example, the output processing may comprises event processor 258, an assignation tool 260, and task manager 262. In one example, the event processor 258 may obtain the output data of each command executed by the execution module 216 for example as logs of information. Further the event processor 258 may, based on the user type, such as administrator or normal user, allocate the output data to user for a feedback in case of normal user and assignation tool in case of administrator user. In one the example, the event processor 258 may allocate the output data based on the event type such as hardware events, security system events, custom settings events, browser events, error log events, authentication events. In one example, events such as are hardware events, security system events, custom settings events may be allocated to the administrator user type, whereas events such as browser events, error log events, authentication events may be allocated to normal user type. Further, in the example, the assignation tool 260 may extract one or more aspects of the output data such as issues or info and build one or more tasks. Furthermore, in the example, upon association the task manager 262 may assign the respective task/event to the users such as UI fixes to User A, Integration Issue to User B.

In the embodiment, the record and replay system 102 comprises user feedback module 268 configured to capture and the back and forth notification and stored internally for further learning and processing.

Exemplary embodiments for automating one or more activities with self-learning discussed above may provide certain advantages. Though not required to practice aspects of the disclosure, these advantages may include those provided by the following features.

Some embodiments of the record and replay system and the method enable improvement in the analysis and helps in troubleshooting.

Some embodiments of the record and replay system and the method provide saving of time is saved, and reduction in risk.

Some embodiments of the record and replay system and the method eliminates issues related to manual debugging.

Some embodiments of the record and replay system and the method minimize effort time and increases the productivity.

Some embodiments of the record and replay system and the method avoid duplicate task executions.

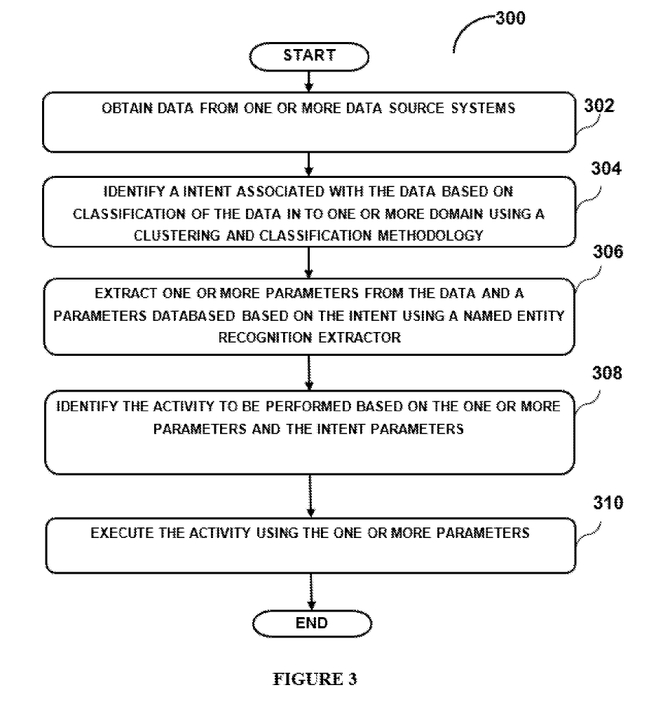

Referring now to FIG. 3, a method 300 for automating execution of one or more activities using a record and replay record and replay system 102, is disclosed in accordance with an embodiment of the present subject matter. The method 300 for automating execution of one or more activities using a record and replay record and replay system 102 may be described in the general context of device executable instructions. Generally, device executable instructions can include routines, programs, objects, components, data structures, procedures, modules, functions, and the like, that perform particular functions or implement particular abstract data types. The method 300 for automating execution of one or more activities using a record and replay record and replay system 102 may also be practiced in a distributed computing environment where functions are performed by remote processing record and replay systems that are linked through a communications network. In a distributed computing environment, computer executable instructions may be located in both local and remote computer storage media, including memory storage record and replay systems.

The order in which the method 300 for automating execution of one or more activities using a record and replay record and replay system 102 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method 300 can be implemented in any suitable hardware, software, firmware, or combination thereof. However, for ease of explanation, in the embodiments described below, the method 300 for automating execution of one or more activities using a record and replay record and replay system 102 may be considered to be implemented in the above-described record and replay system 102.

At block 302, data from one or more data source systems (108) may be obtained. In one example, the data source record and replay system (108) comprises an enterprise CRM record and replay system, file record and replay systems log management record and replay systems, an email record and replay system, device details, errors, and messages. In one embodiment, domain classifier module 212 may obtain data from one or more source systems (108). Further, the receiving module 212 may store the data in the system data 226.

At block 304, an intent associated with the data based on classification of the data in to one or more domain using a clustering and classification methodology. In one embodiment, the domain classifier module 212 may identify an intent associated with the data based on classification of the data in to one or more domain using a clustering and classification methodology, and store the plurality of parameters in the system data 226.

At block 306, one or more parameters may be extracted from the data and parameters databased based on the intent using a named entity recognition extractor. In one embodiment, the custom named entity recognition extractor module 214 may extract one or more parameters may be extracted from the data and parameters databased based on the intent using a named entity recognition extractor and store the one or more parameters system data 226.

At block 308, the activity to be performed is identified based on the one or more parameters and the intent. In one embodiment, the execution module 216 may identify the activity to be performed based on the one or more parameters and the intent. Further, the execution module 216 may store the identified activity in the system data 226.

At block 310, the activity may be executed using the one or more parameter, thereby automating execution of one or more activities. In one implementation, the execution module 216 may execute the activity using the one or more parameter, thereby automating execution of one or more activities.

Although implementations for methods and record and replay systems for automating one or more activities with self-learning have been described in language specific to structural features and/or methods, it is to be understood that the appended claims are not necessarily limited to the specific features or methods for automating one or more activities with self-learning described. Rather, the specific features and methods are disclosed as examples of implementations for automating one or more activities with self-learning.

1. A method for automating execution of one or more activities using a record and replay system, the method comprising:
obtaining, by a processor, data from one or more data source systems wherein the data source system comprises an enterprise CRM system, file systems log management systems, an email system, device details, errors, and messages;
identifying, by the processors, an intent associated with the data based on classification of the data in to one or more domain using a clustering and classification methodology;
extracting, by the processor, one or more parameters from the data and parameters databased based on the intent using a named entity recognition extractor;
identifying, by the processor, the activity to be performed based on the one or more parameters and the intent; and
executing, by the processor, the activity using the one or more parameters, thereby automating execution of one or more activities using a record and replay system.

2. The method of claim 1, further comprising:
identifying, by the processor a recording sequence associated with the activity based on natural language processing of a set of recording sequence and the activity;
generating, by the processor, the recording sequence, when the recording sequence is not available in the set of recording sequences, based on recording of the execution of the activity; and
storing, by the processor, the recording sequence in the set of recording sequence.

3. The method of claim 2, further comprising replaying, by the processor the recording sequence, when the recording sequence is available in the set of recording sequences.

4. The method of claim 1, further comprising:
obtaining, by the processor, output data generated upon execution of the activity, wherein the output data comprises error logs, issues logs and information logs; and
generating, by the processor, one or more tasks based on the output data.

5. The method of claim 1, further comprising:
assigning, by the processor, each of the one or more tasks to one or more users based on the user data.

6. The method of claim 1, further comprising:
receiving, by the processor, an instruction for re-executing the activity from the one or more user; and
re-executing, by the processor, the activity using the recording sequence.

7. A record and replay system for automating one or more activities, the system comprising:
a memory; and
a processor coupled to the memory, wherein the processor is configured to:
obtain data from one or more data source systems wherein the data source system comprises an enterprise CRM system, file systems log management systems, an email system, device details, errors, and messages;
identify an intent associated with the data based on classification of the data in to one or more domain using a clustering and classification methodology;
extract one or more parameters from the data and a parameters databased based on the intent using a named entity recognition extractor;
identify the activity to be performed based on the one or more parameters and the intent; and
execute the activity using the one or more parameter, thereby automating execution of one or more activities.

8. The record and replay system of claim 7 further comprising
identifying a recording sequence associated with the activity based on natural language processing of a set of recording sequence and the activity;
generating the recording sequence, when the recording sequence is not available in the set of recording sequences, based on recording of the execution of the activity; and
storing the recording sequence in the set of recording sequence.

9. The record and replay system of claim 7, further comprising replaying the recording sequence, when the recording sequence is available in the set of recording sequences.

10. The record and replay system of claim 7, further comprising:
obtaining output data generated upon execution of the activity, wherein the output data comprises error logs, issues logs and information logs; and
generating, by the processor, one or more tasks based on the output data.

11. The record and replay system of claim 7, further comprising assigning each of the one or more tasks to one or more users based on the user data.

12. The record and replay system of claim 7, further comprising
receiving an instruction for re-executing the activity from the one or more user; and
re-executing the activity using the recording sequence.
